(19) United States
(12) Patent Application Publication
(10) Pub. No.: US 2026/0104298 A1
(43) Pub. Date: Apr. 16, 2026

(54) Ear Temperature Detection Device

(71) Applicant: Chengdu Fanmi Technology Co., Ltd., Chengdu (CN)

(72) Inventors: Zhuodong LI, Chengdu (CN); Feng ZHOU, Chengdu (CN)

(21) Appl. No.: 19/353,704

(22) Filed: Oct. 9, 2025

(30) Foreign Application Priority Data
Oct. 10, 2024 (CN) 202411412551.9

(51) Int. Cl. G01K 13/20; G01J 5/00; G01J 5/04

(52) U.S. Cl. CPC G01K 13/223; G01J 5/0011; G01J 5/046

(57) ABSTRACT

An ear temperature detection device, which comprises a first heating element and a second heating element. Under the control of a control unit, the first heating element is configured to heat a front end of an infrared detection module, and the second heating element is configured to heat a rear end of the infrared detection module. By heating both the front and rear ends, the overall temperature of the infrared detection module in the direction of infrared incidence (i.e., the front-to-rear direction of the infrared detection module) is made more uniform, reducing or eliminating the temperature gradient issue within the infrared detection module, thereby improving the measurement accuracy of the infrared detection module.

### TECHNICAL FIELD

This application relates to body temperature measurement, specifically to a detection device for measuring ear temperature using infrared detection.

### BACKGROUND ART

An ear temperature detection device (such as an ear thermometer or other device) is a device that measures temperature within the ear canal. Taking an ear thermometer as an example, the detection accuracy of such an ear thermometer is greatly affected by ambient temperature, particularly in cold environments, where low ambient temperatures often cause issues such as lens fogging, thermal shock, and cooling effects, leading to inaccurate temperature measurements. To address this, heating elements are generally incorporated into ear thermometers to provide heating, thereby mitigating issues caused by low ambient temperatures.

However, although some existing ear thermometers are equipped with heating elements, they still fail to address the temperature gradient issue formed within the infrared sensor itself in the direction of infrared incidence. The infrared sensing chip inside the infrared sensor captures the temperature difference between the chip and the target. The aforementioned temperature gradient significantly affects the temperature difference between the chip and the target, resulting in significant measurement deviations.

### SUMMARY OF THE INVENTION

This application provides an ear temperature detection device to improve the accuracy of temperature detection.

To achieve the above objective, some embodiments of this application provide an ear temperature detection device, comprising:
a probe housing, the probe housing comprising a detection end, the detection end comprising a light entrance window, the probe housing enclosing a mounting cavity;
an infrared detection module, the infrared detection module being mounted in the mounting cavity, the infrared detection module comprising a front end facing the light entrance window and a rear end facing away from the front end, the front end being defined toward the light entrance window to allow infrared rays emitted from a detection object to enter the front end through the light entrance window;
a first heating element, the first heating element being configured to heat the front end;
a second heating element, the second heating element being configured to heat the rear end;
and a control unit, electrically connected to the first heating element and the second heating element, configured to control the first heating element and the second heating element to make the temperatures of the front end and the rear end of the infrared detection module consistent or differ by a set value.

In the ear temperature detection device described above, it comprises a first heating element and a second heating element. Under the control of the control unit, the first heating element is configured to heat the front end of the infrared detection module, and the second heating element is configured to heat the rear end of the infrared detection module. By heating both the front and rear ends, the overall temperature of the infrared detection module in the direction of infrared incidence (i.e., the front-to-rear direction of the infrared detection module) is made more uniform, reducing or eliminating the temperature gradient issue within the infrared detection module, thereby improving the measurement accuracy of the infrared detection module.

In some embodiments, in the axial direction of the light entrance window, the first heating element is located on a front side of the front end, and/or the second heating element is located on a rear side of the rear end.

In some embodiments, the first heating element is a first plate-shaped structure, the second heating element is a second plate-shaped structure, the first heating element, the infrared detection module, and the second heating element form a layered structure, and the second plate-shaped structure has a wiring hole through which a connection wire of the infrared detection module passes.

In some embodiments, in the axial direction of the light entrance window, the distance between the first heating element and the infrared detection module is less than or equal to 1 mm.

In some embodiments, the light entrance window is a first through-hole, and the first heating element has a second through-hole.

The tube of the first through-hole is folded toward the side where the infrared detection module is located and inserted into the second through-hole to form an optical tunnel to guide the infrared rays along the optical tunnel toward the infrared detection module; or,
The second through-hole communicates with the first through-hole and together forms at least a portion of an optical tunnel to guide the infrared rays along the optical tunnel toward the infrared detection module; or,
It further comprises an optical guide, the optical guide comprising an optical tunnel for guiding the infrared rays toward the infrared detection module, the optical guide being mounted in the first through-hole and the second through-hole.

In some embodiments, the control unit comprises a first flexible circuit board, one end of the first flexible circuit board is located between the first heating element and the infrared detection module, the first heating element is electrically connected to the first flexible circuit board, and the other end of the first flexible circuit board extends along a side of the infrared detection module to a rear side of the infrared detection module.

In some embodiments, the control unit comprises a second flexible circuit board, one end of the second flexible circuit board is located on a rear side of the second heating element and is electrically connected to the second heating element; the other end of the second flexible circuit board extends toward the rear side along the axial direction of the light entrance window in a manner opposite to the first flexible circuit board; a cavity capable of accommodating other components is formed between the first flexible circuit board and the second flexible circuit board.

In some embodiments, a thermally conductive insulating layer is defined between the first heating element and the infrared detection module, and/or a thermally conductive insulating layer is defined between the infrared detection module and the second heating element.

In some embodiments, it further comprises an insulating layer, the insulating layer being defined around the circumference of the infrared detection module and separating the infrared detection module from the probe housing.

In some embodiments, the control unit independently controls the first heating element and the second heating element, such that the heating temperature of the first heating element and the heating temperature of the second heating element may be different.

In some embodiments, it further comprises at least one first temperature detection unit, the first temperature detection unit being configured to detect the temperature of the front end of the infrared detection module, the first temperature detection unit being electrically connected to the control unit, the control unit adjusting the temperature of the first heating element based on feedback from the first temperature detection unit. In some embodiments, it further comprises at least one second temperature detection unit, the second temperature detection unit being configured to detect the temperature of the rear end of the infrared detection module; the second temperature detection unit is electrically connected to the control unit, the control unit adjusting the temperature of the second heating element based on feedback from the second temperature detection unit.

In some embodiments, the first temperature detection unit at least partially contacts the front end of the infrared detection module, and/or the second temperature detection unit at least partially contacts the rear end of the infrared detection module.

In some embodiments, the distance between the first temperature detection unit and the infrared detection module is less than or equal to 5 mm, and/or the distance between the second temperature detection unit and the infrared detection module is less than or equal to 5 mm.

In some embodiments, the infrared detection module comprises a module housing made of a metal material and a thermoelectric sensing unit located within the module housing, the end of the module housing facing the light entrance window being the front end of the infrared detection module, and the end of the module housing facing away from the front end being the rear end of the infrared detection module.

In some embodiments, a second temperature detection unit is defined within the module housing, the second temperature detection unit being configured to detect the ambient temperature of the thermoelectric sensing unit.

In some embodiments, at least a portion of the probe housing is made of a metal material, and the first heating element and/or the second heating element is in contact with the metal material portion of the probe housing to heat the metal material portion. In some embodiments, the probe housing comprises a probe cap and a cylindrical body, the probe cap being fixedly connected to the cylindrical body to enclose the mounting cavity, the light entrance window being defined on the probe cap, and at least the probe cap being made of a metal material.

In some embodiments, during temperature measurement, the control unit controls the first heating element and the second heating element to maintain heating to ensure that the infrared detection module is in a constant temperature environment.

This application also provides an ear temperature detection device to improve the accuracy of temperature detection.

To achieve the above objective, some embodiments of this application provide an ear temperature detection device, comprising:
A probe housing, the probe housing comprising a detection end, the detection end comprising a light entrance window, the probe housing enclosing a mounting cavity; An infrared detection module, the infrared detection module being mounted in the mounting cavity, the infrared detection module being defined toward the light entrance window to allow infrared rays emitted from a detection object to enter the infrared detection module through the light entrance window;
A heating element, the heating element being configured to heat the infrared detection module;
A control unit, electrically connected to the heating element, configured to control the heating element; and
An insulating layer, the insulating layer being defined around the circumference of the infrared detection module and separating the infrared detection module from the probe housing.

In the ear temperature detection device described above, it comprises a heating element and an insulating layer, the heating element being capable of heating the infrared detection module, while the insulating layer is defined around the circumference of the infrared detection module and separates the infrared detection module from the probe housing. On one hand, this may reduce the dissipation of heat generated by the heating element toward the probe housing, improving the heating efficiency of the heating element for the infrared detection module; on the other hand, it may also ensure that the heat generated by the heating element is better conducted within the infrared detection module itself, making the temperature of the infrared detection module more uniform, thereby making the overall temperature of the infrared detection module in the direction of infrared incidence more uniform, reducing or eliminating the temperature gradient issue within the infrared detection module, and improving the measurement accuracy of the infrared detection module.

In some embodiments, the heating element comprises a first heating element and a second heating element, the infrared detection module comprising a front end facing the light entrance window and a rear end facing away from the front end, the front end being defined toward the light entrance window; in the axial direction of the light entrance window, the first heating element is located on a front side of the front end to heat the front end, and/or the second heating element is located on a rear side of the rear end to heat the rear end; the control unit is electrically connected to the first heating element and the second heating element, configured to control the first heating element and the second heating element to make the temperatures of the front end and the rear end of the infrared detection module consistent or differ by a set value.

In some embodiments, the first heating element is a first plate-shaped structure, the second heating element is a second plate-shaped structure, the first heating element, the infrared detection module, and the second heating element form a layered structure, and the second plate-shaped structure has a wiring hole through which a connection wire of the infrared detection module passes.

In some embodiments, in the axial direction of the light entrance window, the distance between the first heating element and the infrared detection module is less than or equal to 1 mm.

In some embodiments, the first heating element has a second through-hole.

The tube of the light entrance window is folded toward the side where the infrared detection module is located and inserted into the second through-hole to form an optical tunnel to guide the infrared rays along the optical tunnel toward the infrared detection module; or,
The second through-hole communicates with the light entrance window and together forms at least a portion of an optical tunnel to guide the infrared rays along the optical tunnel toward the infrared detection module; or,
It further comprises an optical guide, the optical guide comprising an optical tunnel for guiding the infrared rays toward the infrared detection module, the optical guide being mounted in the light entrance window and the second through-hole.

In some embodiments, the control unit comprises a first flexible circuit board, one end of the first flexible circuit board is located between the first heating element and the infrared detection module, the first heating element is electrically connected to the first flexible circuit board, and the other end of the first flexible circuit board extends along a side of the infrared detection module to a rear side of the infrared detection module.

In some embodiments, the control unit comprises a second flexible circuit board, one end of the second flexible circuit board is located on a rear side of the second heating element and is electrically connected to the second heating element; the other end of the second flexible circuit board extends toward the rear side along the axial direction of the light entrance window in a manner opposite to the first flexible circuit board; a cavity capable of accommodating other components is formed between the first flexible circuit board and the second flexible circuit board.

In some embodiments, a thermally conductive insulating layer is defined between the first heating element and the infrared detection module, and/or a thermally conductive insulating layer is defined between the infrared detection module and the second heating element.

In some embodiments, it further comprises an insulating layer, the insulating layer being defined around the circumference of the infrared detection module and separating the infrared detection module from the probe housing.

In some embodiments, it further comprises at least one first temperature detection unit, the first temperature detection unit being configured to detect the temperature of the front end of the infrared detection module, the first temperature detection unit being electrically connected to the control unit, the control unit adjusting the temperature of the first heating element based on feedback from the first temperature detection unit.

In some embodiments, it further comprises at least one second temperature detection unit, the second temperature detection unit being configured to detect the temperature of the rear end of the infrared detection module; the second temperature detection unit is electrically connected to the control unit, the control unit adjusting the temperature of the second heating element based on feedback from the second temperature detection unit.

In some embodiments, the first temperature detection unit at least partially contacts the front end of the infrared detection module, and/or the second temperature detection unit at least partially contacts the rear end of the infrared detection module.

In some embodiments, the distance between the first temperature detection unit and the infrared detection module is less than or equal to 5 mm, and/or the distance between the second temperature detection unit and the infrared detection module is less than or equal to 5 mm.

In some embodiments, the infrared detection module comprises a module housing made of a metal material and a thermoelectric sensing unit located within the module housing, the end of the module housing facing the light entrance window being the front end of the infrared detection module, and the end of the module housing facing away from the front end being the rear end of the infrared detection module.

In some embodiments, a second temperature detection unit is defined within the module housing, the second temperature detection unit being configured to detect the ambient temperature of the thermoelectric sensing unit.

In some embodiments, at least a portion of the probe housing is made of a metal material, and the first heating element and/or the second heating element is in contact with the metal material portion of the probe housing to heat the metal material portion.

In some embodiments, the probe housing comprises a probe cap and a cylindrical body, the probe cap being fixedly connected to the cylindrical body to enclose the mounting cavity, the light entrance window being defined on the probe cap, and at least the probe cap being made of a metal material.

In some embodiments, during temperature measurement, the control unit controls the first heating element and the second heating element to maintain heating to ensure that the infrared detection module is in a constant temperature environment.

This application also provides an ear temperature detection device to improve the accuracy of temperature detection.

To achieve the above objective, some embodiments of this application provide an ear temperature detection device, comprising:
A probe housing, the probe housing enclosing a mounting cavity;
An infrared detection module, the infrared detection module being mounted in the mounting cavity;
A heating element, at least a portion of the probe housing being made of a metal material, the heating element being in thermal contact with the metal material portion of the probe housing to heat the metal material portion; and
A control unit, the control unit being configured to control the heating element for heating.

In the ear temperature detection device described above, it comprises a heating element, and at least a portion of the probe housing is made of a metal material, the heating element being in thermal contact with the metal material portion of the probe housing to heat the metal material portion, thereby increasing the temperature of the probe housing, which in turn increases the temperature of the entire probe portion, reducing issues affecting detection results due to low ambient temperatures, and improving the measurement accuracy of the infrared detection module.

In some embodiments, the heating element comprises a first heating element and a second heating element, the infrared detection module comprising a front end facing the light entrance window and a rear end facing away from the front end, the front end being defined toward the light entrance window; in the axial direction of the light entrance window, the first heating element is located on a front side of the front end to heat the front end, and/or the second heating element is located on a rear side of the rear end to heat the rear end; the control unit is electrically connected to the first heating element and the second heating element, configured to control the first heating element and the second heating element to make the temperatures of the front end and the rear end of the infrared detection module consistent or differ by a set value.

In some embodiments, the first heating element is a first plate-shaped structure, the second heating element is a second plate-shaped structure, the first heating element, the infrared detection module, and the second heating element form a layered structure, and the second plate-shaped structure has a wiring hole through which a connection wire of the infrared detection module passes.

In some embodiments, in the axial direction of the light entrance window, the distance between the first heating element and the infrared detection module is less than or equal to 1 mm.

In some embodiments, the first heating element has a second through-hole.

The tube of the light entrance window is folded toward the side where the infrared detection module is located and inserted into the second through-hole to form an optical tunnel to guide the infrared rays along the optical tunnel toward the infrared detection module; or,
The second through-hole communicates with the light entrance window and together forms at least a portion of an optical tunnel to guide the infrared rays along the optical tunnel toward the infrared detection module; or,
It further comprises an optical guide, the optical guide comprising an optical tunnel for guiding the infrared rays toward the infrared detection module, the optical guide being mounted in the light entrance window and the second through-hole.

In some embodiments, the control unit comprises a first flexible circuit board, one end of the first flexible circuit board is located between the first heating element and the infrared detection module, the first heating element is electrically connected to the first flexible circuit board, and the other end of the first flexible circuit board extends along a side of the infrared detection module to a rear side of the infrared detection module.

In some embodiments, the control unit comprises a second flexible circuit board, one end of the second flexible circuit board is located on a rear side of the second heating element and is electrically connected to the second heating element; the other end of the second flexible circuit board extends toward the rear side along the axial direction of the light entrance window in a manner opposite to the first flexible circuit board; a cavity capable of accommodating other components is formed between the first flexible circuit board and the second flexible circuit board.

In some embodiments, a thermally conductive insulating layer is defined between the first heating element and the infrared detection module, and/or a thermally conductive insulating layer is defined between the infrared detection module and the second heating element.

In some embodiments, it further comprises an insulating layer, the insulating layer being defined around the circumference of the infrared detection module and separating the infrared detection module from the probe housing.

In some embodiments, it further comprises at least one first temperature detection unit, the first temperature detection unit being configured to detect the temperature of the front end of the infrared detection module, the first temperature detection unit being electrically connected to the control unit, the control unit adjusting the temperature of the first heating element based on feedback from the first temperature detection unit.

In some embodiments, it further comprises at least one second temperature detection unit, the second temperature detection unit being configured to detect the temperature of the rear end of the infrared detection module; the second temperature detection unit is electrically connected to the control unit, the control unit adjusting the temperature of the second heating element based on feedback from the second temperature detection unit.

In some embodiments, the first temperature detection unit at least partially contacts the front end of the infrared detection module, and/or the second temperature detection unit at least partially contacts the rear end of the infrared detection module.

In some embodiments, the distance between the first temperature detection unit and the infrared detection module is less than or equal to 5 mm, and/or the distance between the second temperature detection unit and the infrared detection module is less than or equal to 5 mm.

In some embodiments, the infrared detection module comprises a module housing made of a metal material and a thermoelectric sensing unit located within the module housing, the end of the module housing facing the light entrance window being the front end of the infrared detection module, and the end of the module housing facing away from the front end being the rear end of the infrared detection module.

In some embodiments, a second temperature detection unit is defined within the module housing, the second temperature detection unit being configured to detect the ambient temperature of the thermoelectric sensing unit.

In some embodiments, at least a portion of the probe housing is made of a metal material, and the first heating element and/or the second heating element is in contact with the metal material portion of the probe housing to heat the metal material portion. In some embodiments, the probe housing comprises a probe cap and a cylindrical body, the probe cap being fixedly connected to the cylindrical body to enclose the mounting cavity, the light entrance window being defined on the probe cap, and at least the probe cap being made of a metal material.

In some embodiments, during temperature measurement, the control unit controls the first heating element and the second heating element to maintain heating to ensure that the infrared detection module is in a constant temperature environment.

### BRIEF DESCRIPTION OF THE DRAWINGS

FIG. 1 is a schematic diagram of the external structure of an ear temperature detection device in some embodiments of this application;

FIG. 2 is a cross-sectional view of a probe portion in some embodiments of this application;

FIG. 3 is an exploded schematic diagram of internal components of a probe in some embodiments of this application;

FIG. 4 is a cross-sectional view of a probe portion in other embodiments of this application.

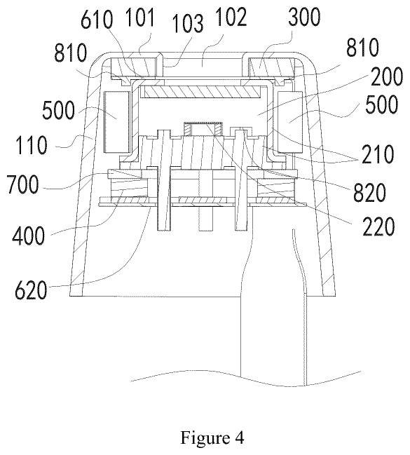

### DETAILED DESCRIPTION OF THE EMBODIMENTS

The present invention is further described in detail below through specific embodiments in conjunction with the accompanying drawings. Similar components in different embodiments are denoted with associated similar reference numerals. In the following embodiments, many details are described to enable a better understanding of this application. However, those skilled in the art may readily recognize that some features may be omitted under different circumstances or may be replaced by other components, materials, or methods. In some cases, certain operations related to this application are not shown or described in the specification to avoid overwhelming the core aspects of this application with excessive description. For those skilled in the art, detailed descriptions of these related operations are not necessary, as they may fully understand the related operations based on the description in the specification and general technical knowledge in the field.

Additionally, the features, operations, or characteristics described in the specification may be combined in any suitable manner to form various embodiments. Meanwhile, the steps or actions in the method descriptions may also be reordered or adjusted in a manner apparent to those skilled in the art. Therefore, the various sequences in the specification and drawings are merely for clearly describing a particular embodiment and do not imply a necessary order unless otherwise specified that a certain order must be followed.

The numbering of components herein, such as “first,” “second,” etc., is used solely to distinguish the described objects and does not imply any order or technical meaning. The terms “connection” and “coupling” in this application, unless otherwise specified, include both direct and indirect connections (couplings).

To solve the problem of inaccurate measurements in existing ear temperature detection devices, particularly in cold environments, some embodiments of this application provide an ear temperature detection device that improves measurement accuracy through a heating element arrangement different from the prior art. The ear temperature detection device may include, but is not limited to, an ear thermometer or other devices that measure body temperature by detecting ear temperature. The detection object may be a human or an animal.

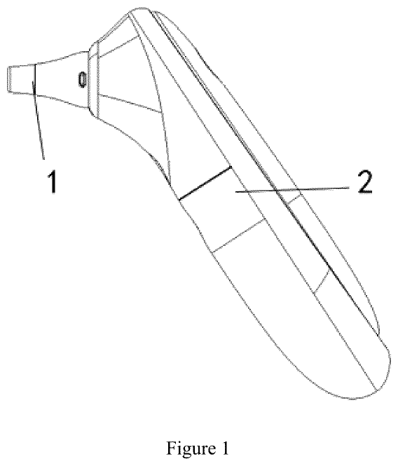

Referring to FIG. 1, in some embodiments, the ear temperature detection device comprises a probe 1 for insertion into or near the ear canal of a detection object and a handle portion 2. In the embodiment shown in FIG. 1, the handle portion 2 is an elongated structure convenient for a user to hold, allowing the user to hold the ear temperature detection device with one hand. Of course, in other embodiments, the handle portion 2 may be configured as other non-elongated structures, such as a square, circular, or other shape convenient for a user to hold with thumb and index finger, and it does not necessarily have to be the elongated shape shown in FIG. 1. In some embodiments, to make the ear temperature detection device more compact, the handle portion 2 may be omitted, and the user may perform temperature measurement by directly grasping the probe 1. In this embodiment, improvements are primarily made to the internal structure of the probe 1, and other structures are not limited.

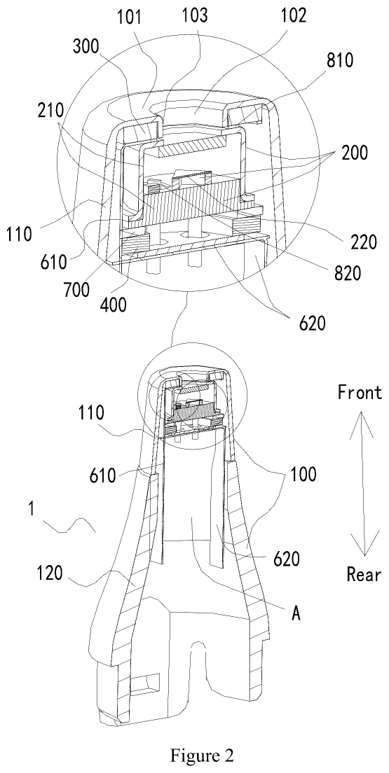

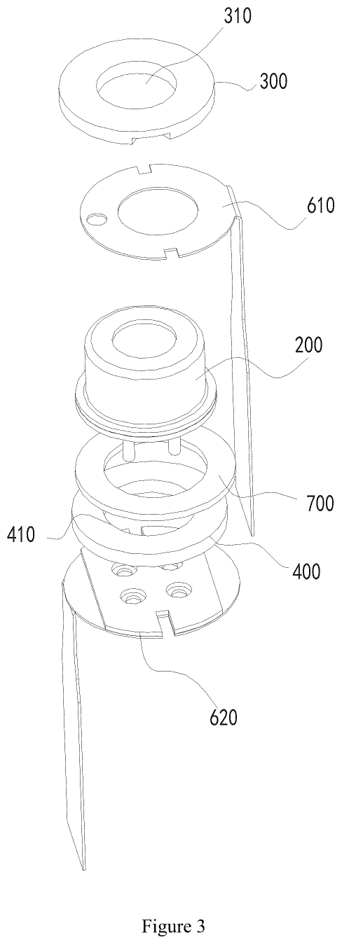

Further, referring to FIGS. 2 and 3, in some embodiments, the probe 1 comprises a probe housing 100, an infrared detection module 200, a first heating element 300, a second heating element 400, and a control unit (e.g., 610, 620). Of course, depending on different requirements, the probe 1 may also include other components, which may refer to the prior art and are not reiterated here.

The probe housing 100 has a detection end 101. The detection end 101 is the end of the probe housing 100 facing the detection object during ear temperature detection, and the detection end 101 is the position where infrared rays emitted from the detection object enter the probe 1.

To allow infrared rays emitted from the detection object to enter the probe 1, the detection end 101 has a light entrance window 102, which is a structure allowing infrared rays to enter. It may be a closed but transparent light-transmissive layer or an opening. For example, in the embodiment shown in FIG. 2, the light entrance window 102 is an opening, referred to here as a first through-hole.

The probe housing 100 encloses a mounting cavity, and the infrared detection module 200 is mounted in the mounting cavity. The infrared detection module 200 has a front end facing the light entrance window 102 and a rear end facing away from the front end. The front-to-rear direction is as shown by the arrow in FIG. 2. The front end is defined toward the light entrance window 102 to allow infrared rays emitted from the detection object to enter the front end through the light entrance window 102. The infrared detection module 200 is a type of component capable of receiving infrared rays and sensing temperature, such as a conventional infrared sensor or other sensor components with a thermoelectric sensing unit.

The control unit is electrically connected to the first heating element 300 and the second heating element 400 and is configured to control the first heating element 300 and the second heating element 400. The first heating element 300 is configured to heat the front end of the infrared detection module 200, and the second heating element 400 is configured to heat the rear end of the infrared detection module 200. Under the control of the control unit, by heating both the front and rear ends of the infrared detection module 200, heat is conducted from both ends toward the middle, making the overall temperature of the infrared detection module 200 in the direction of infrared incidence (i.e., the front-to-rear direction of the infrared detection module 200) more uniform, so that the temperatures of the front end and the rear end of the infrared detection module 200 are consistent or differ by a set value, reducing or eliminating the temperature gradient issue within the infrared detection module 200, thereby improving the measurement accuracy of the infrared detection module 200. The set value may be determined based on specific needs and may be a precise point value or a range.

Moreover, the heat generated by the first heating element 300 and the second heating element 400 may also increase the temperature of the entire probe 1, thereby preventing fogging of the light entrance window 102 of the probe 1, reducing the temperature difference between the infrared detection module 200 and the detection object, and avoiding the probe 1 lowering the temperature of the detection object's tissue, further improving the accuracy of the detection results of the ear temperature detection device.

Additionally, in some embodiments, since the first heating element 300 and the second heating element 400 are separately arranged, the control unit may also control the first heating element 300 and the second heating element 400 independently, so that the heating temperature of the first heating element 300 and the heating temperature of the second heating element 400 may be the same or different as needed, thereby allowing more precise control of the overall temperature of the infrared detection module 200 by adjusting the heating temperatures of the first heating element 300 and the second heating element 400, reducing the temperature gradient of the infrared detection module 200, and more accurately ensuring that the temperatures of the front end and the rear end of the infrared detection module 200 are consistent or differ by a set value. Of course, in some embodiments, to simplify control complexity, the control unit may also control the first heating element 300 and the second heating element 400 synchronously, i.e., the first heating element 300 and the second heating element 400 produce the same temperature change at the same time.

In some embodiments, during temperature measurement, the control unit controls the first heating element 300 and the second heating element 400 to maintain heating to ensure that the infrared detection module 200 is in a constant temperature environment, enabling the infrared detection module 200 to complete detection in a constant temperature environment, thereby improving the accuracy of detection results.

In the above embodiments, the first heating element 300 and the second heating element 400 may employ any heating elements applicable to the field of ear temperature detection, such as, but not limited to, ceramic heating plates, iron-chromium-aluminum heating wires, nickel-chromium heating wires, or other types of heating elements.

To ensure structural compactness, in some embodiments, referring to FIG. 2, in the axial direction of the light entrance window 102, the first heating element 300 is located on a front side of the front end of the infrared detection module 200, and/or the second heating element 400 is located on a rear side of the rear end of the infrared detection module 200. When the light entrance window 102 is a light-transmissive layer, the axial direction of the light entrance window 102 is perpendicular to the light-transmissive layer. When the light entrance window 102 is an opening, the axial direction of the light entrance window 102 is the axial direction of the opening. This arrangement makes full use of the space in the axial direction of the light entrance window 102, aligning with the elongated design of the probe 1, avoiding an increase in the lateral (i.e., radial or perpendicular to the axial direction) dimensions of the probe 1.

Referring to FIGS. 2 and 3, in some more specific embodiments, the first heating element 300 is a first plate-shaped structure, the second heating element 400 is a second plate-shaped structure, and the first heating element 300, the infrared detection module 200, and the second heating element 400 form a layered structure, similar to a sandwich structure. The plate-shaped structure of the heating elements and the layered structure among them may increase the contact area between the first heating element 300, the second heating element 400, and the infrared detection module 200, thereby facilitating heat conduction. Additionally, in other embodiments, when the first heating element 300 and the second heating element 400 are designed to clamp the infrared detection module 200, the first heating element 300 and the second heating element 400 may also serve to fix the infrared detection module 200, improving the positional stability of the infrared detection module 200.

In the above layered structure, referring to FIGS. 2 and 3, in some embodiments, the second heating element 400 has a wiring hole 410, through which a connection wire of the infrared detection module 200 passes. Based on this, the connection wire of the infrared detection module 200 does not need to be led out from the peripheral side of the second heating element 400, avoiding an increase in the lateral dimensions of the probe 1. Of course, in other embodiments, the connection wire of the infrared detection module 200 may also be led out from the peripheral side of the second heating element 400, and this application does not limit this.

In addition to the above positional arrangement of the first heating element 300, the infrared detection module 200, and the second heating element 400, in other embodiments, the first heating element 300 and/or the second heating element 400 may also be at least partially defined on a side of the infrared detection module 200, as long as the first heating element 300 and the second heating element 400 may heat the front end and the rear end of the infrared detection module 200, respectively.

Further, in some embodiments, to ensure the heating effect of the heating elements on the infrared detection module 200, in the axial direction of the light entrance window 102, the distance between the first heating element 300 and the infrared detection module 200 is less than or equal to 1 mm. This arrangement may ensure that the heat from the first heating element 300 is more easily conducted to the front end of the infrared detection module 200, and the heat from the second heating element 400 is more easily conducted to the rear end of the infrared detection module 200. Moreover, this distance design also allows the first heating element 300 and the second heating element 400 to be close to the infrared detection module, improving the compactness of the internal structure of the probe 1. In particular, when the first heating element 300 is located on the front side of the front end and the second heating element 400 is located on the rear side of the rear end, it may ensure a smaller overall lateral dimension of the probe 1 while improving the heating effect of the heating elements on the infrared detection module 200.

In terms of heat conduction, the heat conduction between the heating elements and the infrared detection module 200 may be achieved through direct contact or indirect contact. For example, the first heating element 300 and/or the second heating element 400 may conduct heat by contacting the infrared detection module 200; alternatively, the first heating element 300 and/or the second heating element 400 may conduct heat to the infrared detection module 200 through other intermediate thermally conductive materials.

In some embodiments, a thermally conductive insulating layer is defined between the first heating element 300 and the infrared detection module 200, and/or a thermally conductive insulating layer is defined between the infrared detection module 200 and the second heating element 400. In addition to providing heat conduction, the thermally conductive insulating layer also provides insulation to prevent short-circuit issues.

The thermally conductive insulating layer may be made of a material that is both thermally conductive and insulating. It may be a dedicated thermally conductive insulating layer (e.g., the thermally conductive insulating layer 700 located between the second heating element 400 and the infrared detection module 200) or a component serving other functions that also acts as a thermally conductive insulating layer (e.g., the first flexible circuit board 610 described below).

Further, the control unit is a component capable of outputting control signals and may comprise one or more circuit boards (e.g., flexible circuit boards or PCB boards). Regarding the control of the first heating element 300 and the second heating element 400, they may be directly connected to the same control circuit board or may be controlled by different circuit boards.

For example, referring to FIGS. 2 and 3, in some embodiments, the control unit comprises a first flexible circuit board 610, the first heating element 300 is electrically connected to the first flexible circuit board 610, and the first flexible circuit board 610 controls the first heating element 300.

Referring to FIGS. 2 and 3, in some embodiments, the control unit comprises a second flexible circuit board 620, the second flexible circuit board 620 is electrically connected to the second heating element 400, and the second flexible circuit board 620 controls the second heating element 400.

Certainly, the control unit used to control the first heating element 300 and the second heating element 400 may not use flexible circuit boards and may also use PCB boards for control.

Additionally, in other embodiments, the first heating element 300 and the second heating element 400 may also be connected to the same circuit board via connection wires, with the circuit board controlling the first heating element 300 and the second heating element 400.

Referring to FIGS. 2 and 3, in some embodiments, to improve structural compactness, one end of the first flexible circuit board 610 is located between the first heating element 300 and the infrared detection module 200. At this point, the first flexible circuit board 610 may also serve as a thermally conductive insulating layer between the first heating element 300 and the infrared detection module 200, eliminating the need for an additional thermally conductive insulating layer, simplifying the structure, and reducing the structural volume. The other end of the first flexible circuit board 610 extends along a side of the infrared detection module 200 to a rear side of the infrared detection module 200 to facilitate connection of the first flexible circuit board 610 with other components, such as a main control circuit board of the ear temperature detection device, which is typically defined in the handle portion 2, though this application does not limit this.

Further, referring to FIGS. 2 and 3, in some embodiments, one end of the second flexible circuit board 620 is located on a rear side of the second heating element 400, and the other end of the second flexible circuit board 620 extends toward the rear side along the axial direction of the light entrance window 102 to facilitate connection of the first flexible circuit board 610 with other components, such as a main control circuit board of the ear temperature detection device.

Further, referring to FIGS. 2 and 3, in some embodiments, the first flexible circuit board 610 and the second flexible circuit board 620 extend toward the rear side in a relative manner, making full use of the peripheral space within the probe housing 100, avoiding mutual interference between the first flexible circuit board 610 and the second flexible circuit board 620, and facilitating connection of the first flexible circuit board 610 and the second flexible circuit board 620 with other components. Moreover, this arrangement allows a cavity A capable of accommodating other components to be formed between the first flexible circuit board 610 and the second flexible circuit board 620. When needed, the cavity A may be used to place other components, thereby improving the compactness of the entire probe 1 structure, which is beneficial to reducing the overall size of the probe 1.

On the other hand, to improve the precision of the control unit's temperature control of the infrared detection module 200, in some embodiments, referring to FIG. 2, it further comprises at least one first temperature detection unit 810, the first temperature detection unit 810 being configured to detect the temperature of the front end of the infrared detection module 200, the first temperature detection unit 810 being electrically connected to the control unit, and the control unit adjusting the temperature of the first heating element 300 based on feedback from the first temperature detection unit 810 to more precisely adjust the heating temperature of the first heating element 300.

Further, referring to FIG. 2, in some embodiments, it further comprises at least one second temperature detection unit 820, the second temperature detection unit 820 being configured to detect the temperature of the rear end of the infrared detection module 200; the second temperature detection unit 820 is electrically connected to the control unit, and the control unit adjusts the temperature of the second heating element 400 based on feedback from the second temperature detection unit 820 to more precisely adjust the heating temperature of the second heating element 400. The first temperature detection unit 810 and the second temperature detection unit 820 may be defined either on the outer side or the inner side of the infrared detection module 200.

The first temperature detection unit 810 and the second temperature detection unit 820 may employ any components capable of being used for temperature detection of the infrared detection module 200, such as, but not limited to, NTC temperature sensors or other types of temperature sensors. The first temperature detection unit 810 and the second temperature detection unit 820 may also be electrically connected to the same circuit board, such as a main control circuit board, or may be connected to different circuit boards.

To obtain more accurate temperature information, the first temperature detection unit 810 and the second temperature detection unit 820 may directly contact the infrared detection module 200. Referring to FIG. 2, in some embodiments, the first temperature detection unit 810 at least partially contacts the front end of the infrared detection module 200, and/or the second temperature detection unit 820 at least partially contacts the rear end of the infrared detection module 200.

In some more specific embodiments, the first temperature detection unit 810 at least partially contacts the outer or inner wall of the front end of the infrared detection module 200, and/or the second temperature detection unit 820 at least partially contacts the outer or inner wall of the rear end of the infrared detection module 200.

In the embodiment shown in FIG. 2, the first temperature detection unit 810 contacts the outer wall of the front end of the infrared detection module 200, and the second temperature detection unit 820 contacts the inner wall of the rear end of the infrared detection module 200. In this embodiment, the second temperature detection unit 820 may be pre-assembled within the infrared detection module 200, such as by directly purchasing an infrared detection module 200 with the second temperature detection unit 820, to reduce costs.

Further, to improve the accuracy of temperature detection of the infrared detection module 200, in some embodiments, the distance between the first temperature detection unit 810 and the infrared detection module 200 is less than or equal to 5 mm, and/or the distance between the second temperature detection unit 820 and the infrared detection module 200 is less than or equal to 5 mm.

Further, the infrared detection module 200 used in some embodiments of this application is described here. Referring to FIG. 2, in some embodiments, the infrared detection module 200 comprises a module housing 210 and a thermoelectric sensing unit 220 located within the module housing 210. The module housing 210 serves as the outer shell of the entire infrared detection module 200 and may be an integrally formed structure or assembled from multiple parts. The end of the module housing 210 facing the light entrance window 102 is the front end of the infrared detection module 200, and the end of the module housing 210 facing away from the front end is the rear end of the infrared detection module 200. The thermoelectric sensing unit 220 is configured to receive infrared rays and obtain an electrical signal indicative of the corresponding temperature, such as, but not limited to, a thermopile sensor or other types of sensors.

In some embodiments, to enable better heat conduction in the infrared detection module 200, the module housing 210 is made of a metal material, allowing the heat generated by the first heating element 300 and the second heating element 400 to be quickly conducted on the module housing 210, thereby making the temperature of the entire infrared detection module 200 more uniform to reduce the temperature gradient.

Referring to FIG. 2, in this embodiment, a second temperature detection unit 820 is also defined within the module housing 210, the second temperature detection unit 820 being configured to detect the ambient temperature of the thermoelectric sensing unit 220. The second temperature detection unit 820 and the thermoelectric sensing unit 220 are both defined on the inner wall of the rear end of the module housing 210. Additionally, the second temperature detection unit 820 may also be defined on a side wall of the module housing 210.

On the other hand, to better guide infrared rays toward the infrared detection module 200, in some embodiments, an optical tunnel may be provided, and the infrared light entering the light entrance window 102 may travel along the optical tunnel to enter the infrared detection module 200.

Referring to FIGS. 2 and 3, in some embodiments, the light entrance window 102 is a first through-hole, and the first heating element 300 has a second through-hole 310, wherein the tube 103 of the light entrance window 102 is folded toward the side where the infrared detection module 200 is located and inserted into the second through-hole 310 to form an optical tunnel to guide infrared rays along the optical tunnel toward the infrared detection module 200. In this embodiment, the optical tunnel is formed directly by the probe housing 100, eliminating the need for an additional optical guide to form the optical tunnel, simplifying the internal structure of the probe 1, and facilitating the miniaturization design of the probe 1.

Additionally, the folded tube 103 of the light entrance window 102 passes through the second through-hole 310 of the first heating element 300, which may also serve to limit the position of the first heating element 300, reducing the fixing requirements for the first heating element 300. Meanwhile, through the folded tube 103, the contact area between the first heating element 300 and the probe housing 100 is increased, which is also beneficial to transferring the heat generated by the first heating element 300 to the probe housing 100, thereby increasing the temperature of the probe housing 100.

In some embodiments, the detection end 101 may be made of a metal material, which not only achieves heat conduction but also, due to the low infrared emissivity of metal (within 10%), reduces interference caused by infrared light emitted from the folded tube 103 due to its own heating entering the infrared detection module 200 during the formation of the optical tunnel.

In other embodiments, the second through-hole 310 may communicate with the light entrance window 102 and together form at least a portion of an optical tunnel to guide infrared rays along the optical tunnel toward the infrared detection module 200. Alternatively, in other embodiments, it further comprises an optical guide, the optical guide comprising an optical tunnel for guiding infrared rays toward the infrared detection module 200, the optical guide being mounted in the light entrance window 102 and the second through-hole 310.

To ensure that the heat generated by the heating elements may be more fully and quickly conducted to the entire infrared detection module 200, some embodiments of this application provide additional solutions. Specifically, referring to FIG. 3, in some embodiments, it further comprises an insulating layer 500, the insulating layer 500 being defined around the circumference of the infrared detection module 200 and separating the infrared detection module 200 from the probe housing 100. The insulating layer 500 may be made of any insulating material applicable to the infrared detection module 200, such as insulating cotton or other materials.

When the infrared detection module 200 is covered by the insulating layer 500, on one hand, it may reduce the outward dissipation of heat from the infrared detection module 200, especially preventing dissipation toward the probe housing 100, thereby concentrating more heat on the infrared detection module 200 and improving the heating efficiency of the heating elements for the infrared detection module 200; on the other hand, it may also ensure that the heat generated by the heating elements is better conducted within the infrared detection module 200 itself, making the temperature of the infrared detection module 200 more uniform, thereby making the overall temperature of the infrared detection module 200 in the direction of infrared incidence more uniform, reducing or eliminating the temperature gradient issue within the infrared detection module 200, and improving the measurement accuracy of the infrared detection module 200.

In the above embodiments, the first heating element 300 and the second heating element 400 heat the front end and the rear end of the infrared detection module 200, respectively. With the insulating effect of the insulating layer 500, heat may be quickly conducted from the front end and the rear end of the infrared detection module 200 toward the middle, quickly achieving the purpose of heating the entire infrared detection module 200 and making its temperature uniform.

In other embodiments, after adopting the insulating layer 500, the heating effect of one or more heating elements on the infrared detection module 200, combined with the insulating function of the insulating layer 500, may allow the heat from the heating elements to be more concentratedly conducted to the infrared detection module 200. At this point, the heating element is controlled by the control unit to heat the infrared detection module 200. The position of the heating element may be defined at the front end, rear end, and/or side of the infrared detection module 200. For example, the heating element may adopt the layout and structure of the first heating element 300 and/or the second heating element 400 described above, or it may not adopt the layout and structure of the first heating element 300 and/or the second heating element 400.

On the other hand, regarding the probe housing 100, the probe housing 100 may be an integrally formed structure, such as formed by 3D printing, or may be assembled from two or more components. In the assembled configuration, the sub-components may be fixedly connected or movably connected. Movable connections may, for example, allow one part (e.g., the probe cap 110 described below) to rotate or move axially relative to another part (e.g., the cylindrical body 120 described below) to meet certain functional requirements. In the fixed connection configuration, the sub-components may be non-detachably fixed (e.g., by ultrasonic welding, adhesive bonding, or other methods) or detachably connected (e.g., by screwing, snapping, or other methods).

In the embodiment shown in FIG. 2, the probe housing 100 comprises a probe cap 110 and a cylindrical body 120. The probe cap 110 is fixedly connected to the cylindrical body 120 to enclose the mounting cavity, and the light entrance window 102 is defined on the probe cap 110. In the illustrated embodiment, the fixed connection is a detachable fixed connection to facilitate opening the probe cap 110 for replacing internal components. Of course, in other embodiments, the probe cap 110 and the cylindrical body 120 may also be non-detachably fixed.

Typically, the probe housing 100 is made of a non-thermally conductive material, which makes the temperature of the probe housing 100 prone to differing from the ambient temperature, leading to issues such as fogging and cooling effects, affecting measurement accuracy.

To address this, in some embodiments of this application, at least a portion of the probe housing 100 is made of a metal material, and the ear temperature detection device comprises at least one heating element, which may be the first heating element 300 and/or the second heating element 400 described above or other heating elements. At least one heating element is in thermal contact with the metal material portion of the probe housing 100 to heat the metal material portion, increasing the temperature of the probe housing 100, reducing issues affecting detection results due to low ambient temperatures, and improving the measurement accuracy of the infrared detection module 200.

Further, in some embodiments, referring to FIG. 2, at least the probe cap 110 is made of a metal material, and the light entrance window 102 is defined on the probe cap 110.

Further, in some embodiments, the heating element is in thermal contact with the infrared detection module 200, enabling the heating element to simultaneously heat the probe housing 100 and the infrared detection module 200. For example, when the heating element is the first heating element 300 as shown in FIG. 2, it may heat both the probe housing 100 and the infrared detection module 200.

The above specific examples are used to illustrate the present invention, solely to aid in understanding the invention and not to limit it. For those skilled in the art to which the present invention pertains, based on the concepts of the present invention, several simple deductions, modifications, or substitutions may also be made.

1. An ear temperature detection device, comprising:
a probe housing, the probe housing comprising a detection end, the detection end comprising a light entrance window, the probe housing enclosing a mounting cavity;
an infrared detection module, the infrared detection module being mounted in the mounting cavity, and the infrared detection module comprising a front end facing the light entrance window and a rear end facing away from the front end, the front end being defined toward the light entrance window to allow infrared rays emitted from a detection object to enter the front end through the light entrance window;
a first heating element, the first heating element being configured to heat the front end;
a second heating element, the second heating element being configured to heat the rear end; and
wherein a control unit, electrically connected to the first heating element and the second heating element, configured to control the first heating element and the second heating element to make temperatures of the front end and the rear end of the infrared detection module consistent or differ by a set value.

2. The ear temperature detection device according to claim 1, wherein in an axial direction of the light entrance window, the first heating element is located on a front side of the front end, and/or the second heating element is located on a rear side of the rear end.

3. The ear temperature detection device according to claim 1, wherein the light entrance window is a first through-hole, the first heating element has a second through-hole, wherein,
a tube of the first through-hole is folded toward a side where the infrared detection module is located and inserted into the second through-hole to form an optical tunnel to guide the infrared rays along the optical tunnel toward the infrared detection module;
or, the second through-hole communicates with the first through-hole and together forms at least a portion of an optical tunnel to guide the infrared rays along the optical tunnel toward the infrared detection module;
or, it further comprises an optical guide, the optical guide comprising an optical tunnel for guiding the infrared rays toward the infrared detection module, the optical guide being mounted in the first through-hole and the second through-hole.

4. The ear temperature detection device according to claim 1, wherein the control unit independently controls the first heating element and the second heating element, such that a heating temperature of the first heating element and a heating temperature of the second heating element may be different.

5. The ear temperature detection device according to claim 1, wherein a thermally conductive insulating layer is defined between the first heating element and the infrared detection module, and/or a thermally conductive insulating layer is defined between the infrared detection module and the second heating element.

6. The ear temperature detection device according to of claim 1, further comprising an insulating layer, the insulating layer is defined around a circumference of the infrared detection module and separating the infrared detection module from the probe housing.

7. The ear temperature detection device according to claim 1, further comprising at least one first temperature detection unit and at least one second temperature detection unit, the first temperature detection unit is configured to detect the temperature of the front end of the infrared detection module, the first temperature detection unit is electrically connected to the control unit, the control unit adjusts the temperature of the first heating element based on feedback from the first temperature detection unit; and/or the second temperature detection unit is configured to detect the temperature of the rear end of the infrared detection module, the second temperature detection unit is electrically connected to the control unit, the control unit adjusts the temperature of the second heating element based on feedback from the second temperature detection unit.

8. The ear temperature detection device according to claim 7, wherein the first temperature detection unit at least partially contacts the front end of the infrared detection module, and/or the second temperature detection unit at least partially contacts the rear end of the infrared detection module.

9. The ear temperature detection device according to claim 7, wherein a distance between the first temperature detection unit and the infrared detection module is less than or equal to 5 mm, and/or a distance between the second temperature detection unit and the infrared detection module is less than or equal to 5 mm, or the second temperature detection unit is located within the infrared detection module.

10. The ear temperature detection device according to claim 1, wherein the infrared detection module comprises a module housing made of a metal material and a thermoelectric sensing unit located within the module housing, the end of the module housing facing the light entrance window being the front end of the infrared detection module, and the end of the module housing facing away from the front end being the rear end of the infrared detection module.

11. The ear temperature detection device according to claim 10, wherein a second temperature detection unit is defined within the module housing, the second temperature detection unit being configured to detect the ambient temperature of the thermoelectric sensing unit.

12. The ear temperature detection device according to claim 1, wherein at least a portion of the probe housing is made of a metal material, and the first heating element and/or the second heating element is in contact with the metal material portion of the probe housing to heat the metal material portion.

13. The ear temperature detection device according to claim 12, wherein the probe housing comprises a probe cap and a cylindrical body, the probe cap being fixedly connected to the cylindrical body to enclose the mounting cavity, the light entrance window being defined on the probe cap, and at least the probe cap being made of a metal material.

14. The ear temperature detection device according to claim 1, wherein during temperature measurement, the control unit controls the first heating element and the second heating element to maintain heating.

15. The ear temperature detection device according to claim 1, wherein the control unit comprises a first flexible circuit board, wherein one end of the first flexible circuit board is located between the first heating element and the infrared detection module, the first heating element is electrically connected to the first flexible circuit board, and the other end of the first flexible circuit board extends along a side of the infrared detection module to a rear side of the infrared detection module.

16. The ear temperature detection device according to claim 15, wherein the control unit comprises a second flexible circuit board, wherein one end of the second flexible circuit board is located on a rear side of the second heating element and is electrically connected to the second heating element; the other end of the second flexible circuit board extends toward the rear side along the axial direction of the light entrance window in a manner opposite to the first flexible circuit board; a cavity capable of accommodating other components is formed between the first flexible circuit board and the second flexible circuit board.

17. An ear temperature detection device, comprising:
a probe housing, the probe housing comprising a detection end, the detection end comprising a light entrance window, the probe housing enclosing a mounting cavity;
an infrared detection module, the infrared detection module being mounted in the mounting cavity, the infrared detection module being defined toward the light entrance window to allow infrared rays emitted from a detection object to enter the infrared detection module through the light entrance window;
a heating element, the heating element being configured to heat the infrared detection module;
a control unit, electrically connected to the heating element, configured to control the heating element; and
an insulating layer, the insulating layer being defined around the circumference of the infrared detection module and separating the infrared detection module from the probe housing.

18. The ear temperature detection device according to claim 17, wherein the heating element comprises a first heating element and a second heating element, the infrared detection module comprising a front end facing the light entrance window and a rear end facing away from the front end, the front end being defined toward the light entrance window; in the axial direction of the light entrance window, the first heating element is located on a front side of the front end to heat the front end, and/or the second heating element is located on a rear side of the rear end to heat the rear end; the control unit is electrically connected to the first heating element and the second heating element, configured to control the first heating element and the second heating element to make the temperatures of the front end and the rear end of the infrared detection module consistent or differ by a set value.

19. An ear temperature detection device, comprising:
a probe housing, the probe housing enclosing a mounting cavity;
an infrared detection module, the infrared detection module being mounted in the mounting cavity;
a heating element, at least a portion of the probe housing being made of a metal material, the heating element being in thermal contact with the metal material portion of the probe housing to heat the metal material portion; and
a control unit, the control unit being configured to control the heating element for heating.

20. The ear temperature detection device according to claim 19, wherein the heating element comprises a first heating element and a second heating element, the infrared detection module comprising a front end facing the light entrance window and a rear end facing away from the front end, the front end being defined toward the light entrance window; in the axial direction of the light entrance window, the first heating element is located on a front side of the front end to heat the front end, and/or the second heating element is located on a rear side of the rear end to heat the rear end; the control unit is electrically connected to the first heating element and the second heating element, configured to control the first heating element and the second heating element to make the temperatures of the front end and the rear end of the infrared detection module consistent or differ by a set value.
